(19) United States
(12) Patent Application Publication
(10) Pub. No.: US 2019/0227555 A1
(43) Pub. Date: Jul. 25, 2019

(54) METHODS AND SYSTEMS FOR ASSISTING OPERATION OF A ROAD VEHICLE WITH AN AERIAL DRONE

(71) Applicant: GM GLOBAL TECHNOLOGY OPERATIONS LLC, Detroit, MI (US)

(72) Inventors: David Sun, Shanghai (CN); Peggy Wang, Shanghai (CN); Jian Yao, Shanghai (CN); Chengwu Duan, Shanghai (CN); Jiang L. Du, Beaverton, OR (US)

(73) Assignee: GM GLOBAL TECHNOLOGY OPERATIONS LLC, Detroit, MI (US)

(21) Appl. No.: 15/876,660

(22) Filed: Jan. 22, 2018

(51) Int. Cl. G05D 1/00; G08G 1/14; G06K 9/00; B64D 47/02; B64C 39/02; B60Q 1/02; G05D 1/02

(52) U.S. Cl. CPC G05D 1/0094; G08G 1/142; G06K 9/00651; B64D 47/02; G05D 2201/0213; B60Q 1/02; G05D 1/0212; B64C 2201/127; B64C 2201/145; B64C 39/024

(57) ABSTRACT

Methods and systems for assisting operation of a road vehicle with an aerial drone are provided. In an exemplary embodiment, a method for assisting operation of a road vehicle with an aerial drone includes flying the aerial drone on a route ahead of the road vehicle and sensing an object at a location on the route ahead of the road vehicle with the aerial drone. Further, the method includes communicating data associated with the object and/or the location to the road vehicle. Also, the method includes utilizing the data to operate the road vehicle.

### INTRODUCTION

Road vehicles, such as automotive vehicles, are generally limited to the confines of the roadway on which they are traveling. While the vehicle may be provided with a global position system (GPS) providing information about the roadway ahead, the road vehicle is typically limited in knowledge regarding more immediate situations. This is true of road vehicles driven by a user, i.e., driver, or in an autonomous driving mode.

For example, a road vehicle typically does not have advance knowledge of conditions on the roadway ahead such as aggressive drivers, disabled vehicles (including automobiles, motorcycles and bicycles), unsafe or non-conforming vehicles (such as a vehicle with an opened door, trunk, gas tank door, electric charge door, or the like), or unsafe pedestrians in or around the roadway.

It is desirable to provide the capability to observe a situation, such as an ongoing condition or an event, occurring in the roadway in the road vehicle's direction of travel but beyond the road vehicle's line of sight, whether the line of sight of a driver or of a vehicle-mounted sensor, such as camera, radar or lidar unit. Such capability may be provided by an aerial drone associated with the road vehicle. Further, it may be desirable to communicate images of the observed situation to the road vehicle for review by a driver or processor in the road vehicle.

Also, in parking situations, it may be desirable to provide information regarding the location of an available parking spot. Further, it may be desirable to lead the road vehicle to the parking spot. Also, it may be desirable to lead a pedestrian back to a parked vehicle in a parking lot.

Accordingly, it is desirable to provide methods and systems for assisting operation of a road vehicle with an aerial drone. Further, it is desirable to provide aerial drones that are associated with vehicles or with defined locations to communicate to road users. Furthermore, other desirable features and characteristics will become apparent from the subsequent detailed description and the appended claims, taken in conjunction with the accompanying drawings and the introduction.

### SUMMARY

Methods and systems for assisting operation of a road vehicle with an aerial drone are provided. In an exemplary embodiment, a method for assisting operation of a road vehicle with an aerial drone includes flying the aerial drone on a route ahead of the road vehicle and sensing an object at a location on the route ahead of the road vehicle with the aerial drone. Further, the method includes communicating data associated with the object and/or the location to the road vehicle. Also, the method includes utilizing the data to operate the road vehicle.

In exemplary embodiments, the method for assisting operation of a road vehicle with an aerial drone further includes determining that a high risk zone is on the route ahead of the road vehicle, and launching the aerial drone from the road vehicle before the road vehicle reaches the high risk zone, wherein flying the aerial drone on the route ahead of the road vehicle comprises flying the aerial drone in the high risk area. In exemplary embodiments, determining that a high risk zone is on the route ahead of the road vehicle includes performing a map data analysis to determine whether a road curvature of the route is greater than a safe curvature and whether an altitude gradient of the route is greater than a safe altitude gradient. In other exemplary embodiments, determining that a high risk zone is on the route ahead of the road vehicle comprises compiling and reviewing traffic accident data for the route ahead of the road vehicle.

In exemplary embodiments, the method for assisting operation of a road vehicle with an aerial drone further includes determining that no high risk zone is on the route ahead of the road vehicle, and recalling and landing the aerial drone on the road vehicle.

In certain embodiments, sensing the object at the location on the route ahead of the road vehicle with the aerial drone includes operating a radar sensor on the aerial drone to detect the object and acquire the relative position of the object. In other embodiments, sensing the object at the location on the route ahead of the road vehicle with the aerial drone comprises operating a sensor unit on the aerial drone to detect the object and acquire the relative position of the object.

In exemplary embodiments, communicating data associated with the object and/or the location to the road vehicle includes transmitting the data to a processor onboard the road vehicle. In exemplary embodiments, the method for assisting operation of a road vehicle with an aerial drone further includes uploading the data associated with the object and/or the location to a cloud database.

In exemplary embodiments, the method for assisting operation of a road vehicle with an aerial drone further includes attempting to recognize the object from the data, and, if the object is not recognized, directing the aerial drone to capture more data associated with the object. Further, in exemplary embodiments, the method for assisting operation of a road vehicle with an aerial drone further includes attempting to recognize the object from the data, and, if the object is recognized, directing the aerial drone to stop capturing data associated with the object and to continue sensing for other objects.

In another embodiment, a method for locating a parking location with an aerial drone is provided. The method for locating a parking location with an aerial drone includes entering a request from a user for the parking location. Also, the method for locating a parking location with an aerial drone includes identifying the parking location. Further, the method for locating a parking location with an aerial drone includes operating the aerial drone to lead the user to the parking location.

In certain embodiments of the method for locating a parking location with an aerial drone, the aerial drone leads the user in a road vehicle to the parking location. In other embodiments of the method for locating a parking location with an aerial drone, the aerial drone leads the user to a road vehicle parked in the parking location.

In exemplary embodiments, entering the request from the user for the parking location comprises communicating the request to a server, the server identifies the parking location, and the server assigns the aerial drone to lead the user to the parking location. In other embodiments, the aerial drone is associated with the road vehicle, entering the request from the user for the parking location comprises communicating the request to a server, the server identifies the parking location, and the server communicates the parking location to the aerial drone.

In exemplary embodiments, entering the request from the user for the parking location comprises entering a road vehicle identifier of a parked road vehicle, entering the request from the user for the parking location comprises communicating the road vehicle identifier of the parked road vehicle to a server, the server identifies the parking location of the parked road vehicle, and the server assigns the aerial drone to lead the user to the parking location.

In another embodiment, a method for assisting operation of a road vehicle with an aerial drone includes flying the aerial drone on a route ahead of the road vehicle, and emitting light from the aerial drone to improve visibility of the route ahead of the road vehicle.

In exemplary embodiments, the method for assisting operation of a road vehicle with an aerial drone includes communicating a command from a drone control module in the road vehicle to activate the aerial drone to emit light, wherein flying the aerial drone on the route ahead of the road vehicle comprises controlling the distance between the aerial drone and the road vehicle with the drone control module.

In exemplary embodiments, the method for assisting operation of a road vehicle with an aerial drone includes sensing light conditions on the route ahead of the road vehicle with a light sensor on the aerial drone, wherein the aerial drone emits light in response to low light conditions sensed by the light sensor.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The present subject matter will hereinafter be described in conjunction with the following drawing figures, wherein like numerals denote like elements, and wherein:

FIG. 1 is a schematic representation of an exemplary embodiment of a road vehicle on a roadway and a deployed aerial drone in accordance with embodiments herein;

FIG. 2 is a schematic view of the aerial drone of FIG. 1 in accordance with embodiments herein;

FIG. 3 is a flow chart illustrating embodiments of a method for assisting communication between a primary road vehicle and other road users; and

FIG. 4 is a flow chart illustrating another embodiment of a method for assisting communication between a primary road vehicle and other road users.

FIG. 5 is a schematic representation of an exemplary embodiment of a road vehicle on a roadway and a deployed aerial drone in accordance with embodiments herein;

FIG. 6 is a flow chart illustrating embodiments of a method for assisting operation of a road vehicle with an aerial drone;

FIG. 7 is a flow chart illustrating a further embodiment of a method for assisting operation of a road vehicle with an aerial drone;

FIG. 8 is a flow chart illustrating embodiments of a method for assisting operation of a road vehicle with an aerial drone; and

FIGS. 9 and 10 are schematic representations of exemplary embodiments of a road vehicle in a parking lot and a deployed aerial drone in accordance with embodiments herein.

### DETAILED DESCRIPTION

The following detailed description is merely illustrative in nature and is not intended to limit the embodiments of methods and systems for assisting operation of a road vehicle with an aerial drone. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Embodiments herein may be described below with reference to schematic or flowchart illustrations of methods, systems, devices, or apparatus that may employ programming and computer program products. It will be understood that blocks, and combinations of blocks, of the schematic or flowchart illustrations, can be implemented by programming instructions, including computer program instructions. These computer program instructions may be loaded onto a computer or other programmable data processing apparatus (such as a controller, microcontroller, or processor) to produce a machine, such that the instructions which execute on the computer or other programmable data processing apparatus create instructions for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks. Programming instructions may also be stored in and/or implemented via electronic circuitry, including integrated circuits (ICs) and Application Specific Integrated Circuits (ASICs) used in conjunction with sensor devices, apparatuses, and systems.

Embodiments herein provide for assisting operation of a road vehicle with an aerial drone. Effectively, the methods, systems, and aerial drones described herein may provide for or support improved safety for the road vehicle and for a social network of road users.

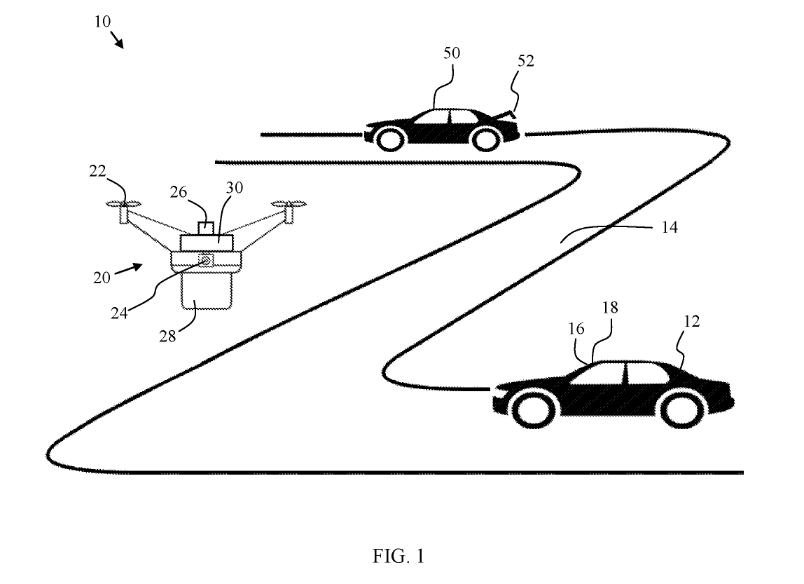

FIG. 1 is a schematic representation of an exemplary embodiment of a system 10 for assisting operation of a road vehicle with an aerial drone. In FIG. 1, the system 10 includes a primary road vehicle 12 that is shown traveling on a roadway 14. While the primary road vehicle 12 is illustrated as being a car, any suitable road vehicle may be provided.

As shown, the primary road vehicle 12 is associated with and in communication with an aerial drone 20 through a transmitter/receiver, i.e., transceiver 16, located on the primary road vehicle 12. The exemplary primary road vehicle 12 also includes a processor/control unit 18.

An exemplary aerial drone 20 may be an unmanned quadrotor helicopter (“quadcoptor”) that is lifted and propelled by four rotors 22. An exemplary aerial drone 20 is paired with the primary road vehicle 12 to communicate information to and receive information from the primary road vehicle 12. Specifically, the exemplary aerial drone 20 includes a transceiver 26 for communicating with the transceiver 16 on the primary road vehicle 12.

As further shown, the aerial drone 20 includes an image capture or sensor unit 24 for observing the roadway 14, recording video and/or capturing images thereof. An exemplary sensor unit 24 may be a camera, a color sensitive light sensor, or a photosensor (such as a charge coupled device array as commonly found in digital cameras).

The exemplary aerial drone 20 further includes a visual display unit 28. For example, the display unit 28 may be a foldable, flexible or articulating screen. An exemplary display unit 28 includes a liquid-crystal display (LCD), a light-emitting diode (LED) based video display, or another electronically modulated optical device. The display unit 28 may be mounted on the bottom, top, or side of the aerial drone 20. Further, the display unit 28 may be movable from a stored position to a use position, such as by opening, unfolding and/or articulating. The display unit 28 may be deployed automatically or may deploy upon command from the primary road vehicle 12. The exemplary aerial drone 20 also includes a processor/controller unit 30. The processor/controller unit 30 may include additional sensors, such as a global positioning system (GPS), an ultrasonic sensor and/or accelerometer to map positions of the aerial drone 20 and the primary road vehicle 12. The sensors provide location data such as a position of the aerial drone 20 relative to the primary road vehicle 12 and the roadway 14.

The primary road vehicle 12 may be provided with a launch and landing pad for the aerial drone 20, such that the aerial drone 20 may be selectively launched or deployed from the primary road vehicle 12 as desired. For example, a user of the primary road vehicle 12 may direct launch and use of the aerial drone 20. The user may send an instruction through actuating a button or screen selection disposed within the vehicle cabin or on a key fob. The control unit 18 receives a signal indicative of a user request to launch the aerial drone 20. Alternatively, the processor/control unit 18 of the primary road vehicle may automatically direct launch and flight of the aerial drone 20 via communication between the transceivers 16 and 26.

FIG. 1 further illustrates a second road user 50 on the roadway 14. In the illustrated embodiment, the second road user 50 is a second vehicle, though the second road user may be any other type of road user. In the embodiment of FIG. 1, the trunk of the second vehicle is opened. The open trunk may constitute a situation that can be identified by the system 10 and resolved by communication with the second road user 50. As can be seen in FIG. 1, the layout of the roadway 14 would make direct viewing of the open trunk of the second vehicle difficult for a driver or passenger in the primary road vehicle 12. However, the aerial drone 20 is able to move more freely, without restriction to the path of the roadway, and may capture images of the open trunk for use as described below. Therefore, the aerial drone 20 provides an advantageous view as compared to the primary road vehicle 12.

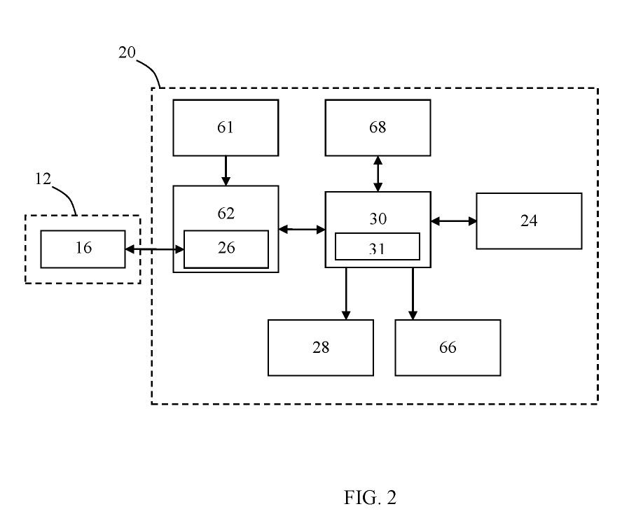

FIG. 2 is a schematic illustration of the exemplary aerial drone 20 of FIG. 1. In FIG. 2, the aerial drone 20 includes the processor 30 interconnected with the camera 24, the transceiver 26, and the display unit 28, as previously illustrated in FIG. 1. As shown, the transceiver 26 is adapted for communication to and from the transceiver 16 mounted on the primary road vehicle 12.

In FIG. 2, the transceiver 26 is shown as being part of a communications module 62, such as a V2X communications module. An exemplary transceiver 26 is a dual RF transceiver. The communications module 62 may further include an antenna or connectivity unit. While shown as an independent entity, the communications module 62 may be considered to be part of the processor 30. As further shown, the aerial drone 20 further includes a location device 61, such as a global positioning system (GPS) and a compass. The location device 61 is connected to the communications module 62 to transmit location information, such as position, orientation, and direction of travel to the communications module 62. The processor 30 may further include autopilot software or vehicle drone control module 31 for command and controlling flight of the aerial drone 20. Also, the processor 30 may include a display control module for controlling the display unit 28 and a camera control module for controlling the camera 24. As shown, the aerial drone 20 may further include a speaker unit 66 for audio transmission of information directly from the aerial drone 20. The processor 30 may include an audio control module for controlling the speaker 66. The aerial drone may also include a lighting unit 68. An exemplary lighting unit 68 includes a light sensor and a lamp for emitting light. The processor 30 may include a light control module for controlling the lighting unit 68.

While communication from the primary road vehicle 12 to the aerial drone 20 is provided between transceivers 16 and 26, in other embodiments, a network, such as a 5G, wifi or Bluetooth network may be provided to enable direct communication from the vehicle processor 18 and the processor 30 of the aerial drone 20. Network communication may be particularly suitable for transferring images and video.

While not illustrated, the aerial drone 20 may include other components. For example, the aerial drone 20 will include a power source, such as a battery, for powering the rotors, camera 24, display unit 28, speaker 66, location device 61, lighting unit 68 and computer processing and modules.

As illustrated in FIG. 2, the aerial drone 20 is provided for automated flight control, image recording, and transmission of images to the primary road vehicle 12. For example, a user in primary road vehicle 12 may activate or direct flight of the aerial drone 20 via a communication from the transceiver 16 or a network to the aerial drone processor 30. The aerial drone processor 30 may control the rotors 22 to launch the aerial drone 20 from the primary road vehicle 12 and to control flight thereafter. Information from the location device 61 is used by the aerial drone processor 30 to navigate to a desired location ahead of the primary road vehicle 12. Communication with the primary road vehicle 12 allows the aerial drone 20 to maintain a suitable distance ahead of the primary road vehicle 12 along the roadway. The communications module 62 on the aerial drone 20 provides for communication with the primary road vehicle to obtain the speed and direction of travel of the primary road vehicle. Further, the communications module 62 may provide for communication with infrastructure via a road side unit (RSU). The RSU can in turn broadcast the information to other users or vehicles within certain distance with range of the RSU.

In certain embodiments, the primary road vehicle may not be provided with V2X communication capabilities while the aerial drone is capable of V2X communication. In such embodiments, the aerial drone may communicate with other road users or with infrastructure and then transfer information to the primary road vehicle in another format.

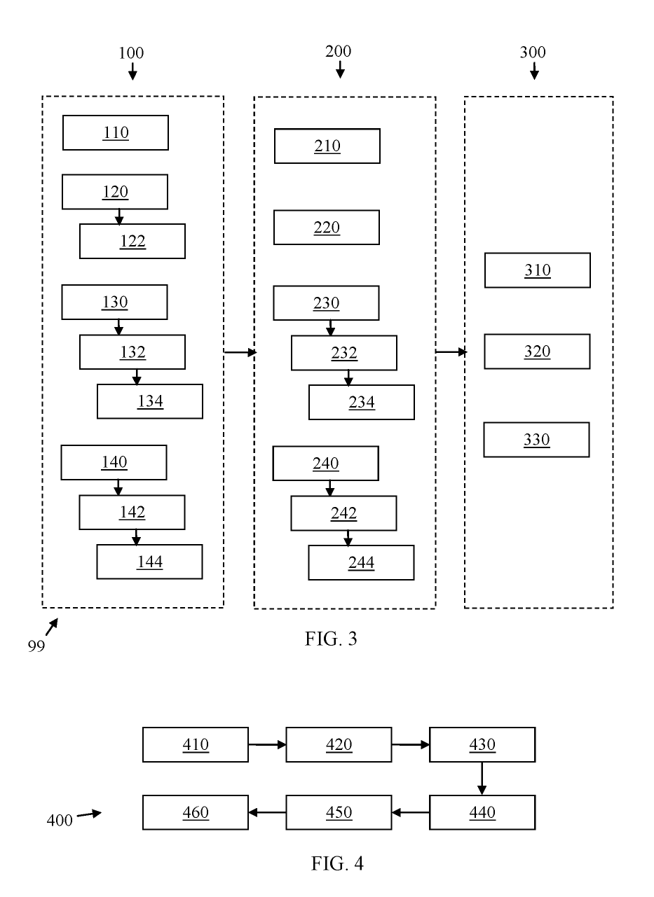

FIG. 3 illustrates various embodiments of a method 99 for assisting communication between a primary road vehicle and other road users, such as other automobiles, motorcycles, bicycles, pedestrians, or other potential road users. In FIG. 3, the illustrated method 99 includes observing a situation at action block 100. After observing a situation, the method 99 includes directing an aerial drone to a second road user at action block 200. Further, after directing the aerial drone to the second road user, the method 99 includes communicating information about the situation from the aerial drone to the second road user at action block 300.

As used herein, the situation that is observed may be an action or condition that is pre-determined or pre-classified as being of interest, and identified through an automated process performed by a processor. Alternatively, the situation that is observed may be identified in real time without prior classification, such as by a driver or other vehicle user. Further, the situation may be observed through a semi-automated process that also includes operator input.

The situation that is observed may be an action or condition that is dangerous or hazardous, a nuisance, or merely unexpected. For example, the situation may be a disabled vehicle (including automobiles, motorcycles and bicycles), unsafe or non-conforming vehicles (such as a vehicle with an opened door, trunk, gas tank door, electric charge door, or the like), or unsafe pedestrians in or around the roadway. Further, the situation may be another road user performing aggressive road maneuvers, e.g., an aggressive driver.

As shown in FIG. 3, in certain embodiments, the action of observing the situation 100 may be performed at action block 110 by a primary user in the primary road vehicle, such as a driver or other vehicle occupant, directly observing the situation.

Alternatively, the action of observing the situation 100 may be performed at action block 120 by capturing images with the aerial drone. The method continues at action block 122 by comparing the captured images with pre-defined events in a processor onboard the aerial drone to identify the situation. For example, the exemplary processor includes an algorithm, which can be machine learning based and/or rule based. The processor will automatically recognize the images which correspond to images of pre-defined events and hence identify the situation.

At action block 130, the action of observing the situation 100 also may be performed by capturing images with the aerial drone. However, the method continues at action block 132 by communicating the captured images from the aerial drone to a processor onboard the primary road vehicle. At action block 134, the processor compares the images with pre-defined events in the processor to identify the situation.

In a semi-automated/semi-operator driven process, at action block 140, the action of observing the situation 100 is again performed by capturing images with the aerial drone and the method continues at action block 142 by communicating the captured images from the aerial drone to a processor onboard the primary road vehicle. At action block 144, a primary user in the primary road vehicle reviews the images to identify the situation. For example, the processor onboard the primary road vehicle may present the capture images for review by the primary user in the primary road vehicle, such as on a heads up display (HUD), a center stack screen, or another visual display within the primary road vehicle.

After the presence of a situation is identified in action block 100, method 99 continues with directing the aerial drone to a second road user at action block 200. In certain cases, the second road user is the observed situation, or is the cause of the observed situation. For example, an improperly hitched trailer may be attached to the second road user's vehicle. In other cases, the second road user may be another party with no connection to the observed situation. For example, the second road user may be an automobile traveling near the primary road user, and the observed situation may be an aggressive driver one-half mile ahead.

The action of directing the aerial drone to the second road user 200 may include utilizing an object tracking system onboard the aerial drone at action block 210. Alternatively, the action of directing the aerial drone to the second road user 200 may be performed by the primary user or an onboard processor issuing a command from the primary road vehicle to the aerial drone at action block 220.

Alternatively, the action of directing the aerial drone to the second road user 200 may include communicating the situation to a primary user in the primary road vehicle at action block 230. The primary user may designate a second road user at action block 232 and information about the second road user, e.g., license plate number, location relative to primary road vehicle, may be communicated to the aerial drone. At action block 234, the aerial drone targets the second user based on the information.

After directing the aerial drone to the second road user at action block 200, the method includes communicating information about the situation from the aerial drone to the second road user at action block 300. In certain embodiments, the aerial drone may travel alongside or hover near the second road user. In other embodiments, the aerial drone may land on the second road user.

At action block 310 the aerial drone visually displays text to the second road user. For example, the aerial drone may display a message such as “CHECK TRAILER” to the second road user. Alternatively, the aerial drone visually displays video to the second road user at action block 320. For example, the aerial drone may display still or moving images of the observed situation. Alternatively or additionally, the aerial drone transmits an audio alert to the second road user at action block 330.

As illustrated in FIG. 3, multiple embodiments of a method 99 for assisting communication between a primary road vehicle and other road users are provided. In certain embodiments, the aerial drone captures images with a camera and an embedded processor on the aerial drone performs image processing and recognition based on pre-defined events or conditions. In other embodiments, the aerial drone communicates the captured images to a processor onboard the primary road vehicle for image processing and recognition. In other embodiments, a user of the primary road vehicle detects the situation without processor recognition. In such embodiments, the user may view the situation directly, i.e., without a presentation of the image on a display unit or screen, or indirectly, i.e., via a presentation on a display unit or screen of images captured by the aerial drone.

Further, after observation of (and recognition of) a situation, the aerial drone flies to and targets the second road user. In certain embodiments, the aerial drone includes embedded object tracking and following functionality such that the aerial drone may target the second road user itself. In other embodiments, a user in the primary road vehicle may designate a remote road user as the second road user and use the aerial drone to target the second road user. For example, the user in the primary road vehicle may designate and target the second road user based on V2X message, including information such as a vehicle license plate, a vehicle model, or other descriptive information.

After the aerial drone flies to the second road user, information about the situation is communicated from the aerial drone to the second road user. For example, the aerial drone may visually display a warning message about the situation, an image of the situation, and/or a video of an event. Alternatively or additionally, the aerial drone may transmit an audio message, such as a recorded audio message or a message generated by text to speech (TTS).

In certain applications, information is communicated from the aerial drone to a single other road user. In other applications, a plurality of other road users may be targeted and communicated with by the aerial drone. In such embodiments, the aerial drone may broadcast information through visual display and/or audio speakers. Also, the aerial drone may communicate with a plurality of other road users through V2X communication. For example, the primary road vehicle may communicate the message to the aerial drone via V2X communication, and the aerial drone may then communication the message to other road users via V2X communication. If applicable, the second road user may receive the V2X communication and present it through a visual display of the vehicle or an audio message transmitted by the vehicle speaker system.

It is also contemplated that the second road user may be outfitted for two way communication with the aerial drone. For example, the second road user may include a processor and transceiver capable of communicating with the processor and transceiver onboard the aerial drone. Further, the second road user may have an aerial drone landing pad to facilitate communication with the aerial drone. As a result, the second road user may communicate information in the form of text messages, captured images, video, and the like to the primary road vehicle via the aerial drone. Such communication may occur via a wireless transceiver to transceiver transmission, or through a wired connection if the aerial drone is received on the landing pad.

FIG. 4 illustrates an embodiment of a method 400 for assisting communication between a primary road vehicle and other road users, such as other automobiles, motorcycles, bicycles, pedestrians, or other potential road users. In FIG. 4, the illustrated method 400 includes a driver or user of the primary road vehicle initiating a request to communicate with another road user at action block 410. For example, the request can be made through a voice command or command input at the primary road vehicle processor. The request is then communicated from the primary road vehicle to the aerial drone in the form of a V2X communication.

At action block 420, the aerial drone broadcasts the request to surrounding road users. For example, the aerial drone may communicate the request to the other road users via a V2X communication.

At action block 430, a select road user accepts the request from the aerial drone by sending an acceptance communication to the aerial drone. Included in each acceptance communication is identification information associated with the other road user, e.g., a license plate number, vehicle brand and model, vehicle appearance, road user location, and the like. The aerial drone forwards the acceptance communication to the primary road vehicle.

At action block 440, the aerial drone determines the location of the select road user by location device, such as by GPS, or by the vehicle identification information included in the acceptance communication, and identifies the select road user. At action block 450, the aerial drone flies to and lands on a landing pad of the select road user. Upon landing, a wired connection may be formed between the aerial drone and the select road user. Alternatively, a wireless connection may be used for communication. At action block 460, the aerial drone transmits information, such as streaming video, images, or messages between the primary road vehicle and the select road user.

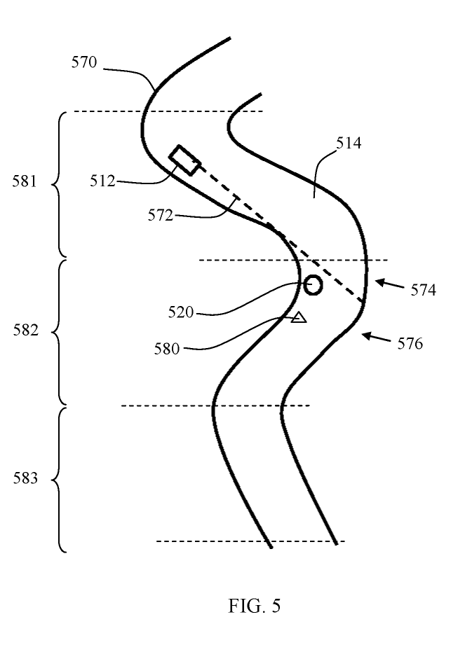

FIG. 5 is a schematic representation of an exemplary embodiment of a system 510 for assisting operation of a road vehicle 512 with an aerial drone 520 in use. In FIG. 5, the road vehicle 512 is traveling on a roadway 514 that is bounded by a visual obstruction 570 such as a hillside, forest, wall or noise barrier, or the like. As a result, the line of sight 572 of the road vehicle 512 is limited by the obstruction 570, as shown. Specifically, for a road vehicle 512 operated by a driver, the driver's line of sight 572 is limited by the obstruction 570. Likewise, for an autonomous operated or driverless road vehicle 512, the line of sight 572 of the vehicle-mounted sensor, e.g., camera, radar or lidar unit, is limited by the obstruction 570. In FIG. 5, the portion 574 of the roadway 514 is visible to the road vehicle 512, while the portion 576 of the roadway 514 is hidden and not visible to the road vehicle 512.

As shown in FIG. 5, the aerial drone 520 is located in a position with a line of sight of the portion 576 of the roadway 514. As a result, the aerial drone 520 may sense an object 580 at a location on the route ahead of the road vehicle 512 that is in the portion 576 of the roadway 514 otherwise hidden from the road vehicle 512. As further shown, the roadway 514 may be considered to include sequential segments, such as those segments 581, 582 and 583, which may be utilized as described below.

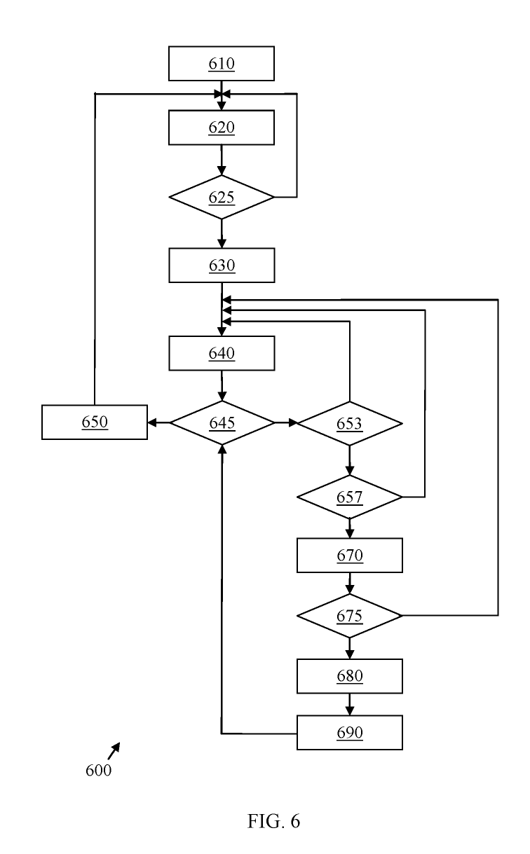

FIG. 6 illustrates an exemplary method 600 for assisting operation of a road vehicle 512 with an aerial drone 520. Method 600 provides for an aerial drone to detect and perceive the remote driving environment, i.e., the roadway that cannot be viewed by the road vehicle, in a challenging road environment for a vehicle, whether driven by a user or autonomous. The method 600 leverages the aerial drone's flying capabilities to effectively increase the road vehicle driver's visible range or to enhance perception of sensors in an autonomous vehicle.

As shown, at action block 610 the road vehicle is started and may begin traveling. Route planning or updating is performed at action block 620. For example, a destination may be entered or otherwise selected by a user. An onboard processor may determine and analyze possible routes and select or request selection of a route.

At inquiry block 625, the processor inquires whether a high risk zone exists on the route. Generally, a high risk zone is defined by a greater likelihood of a collision or a need to reduce velocity to travel safely. Curvature of the roadway, altitude gradient along the radius of the roadway, speed limit, and a history of traffic accidents may indicate a high risk zone. In an exemplary embodiment, a high risk zone may be identified by compiling and reviewing traffic accident data for the route ahead of the road vehicle. Alternatively, a high risk zone may be identified by performing a hypsographic map data analysis to determine whether a road curvature of the route is greater than a safe curvature (K) and/or whether an altitude gradient of the route is greater than a safe altitude gradient (h). There are two cases for the altitude gradients: 1) the gradient along the route, covering the actual path traveled by the vehicle while going uphill and downhill, and 2) the gradient along the radius direction of the route, covering circumstances when the route travels close to a cliff or other geographic feature with a large altitude gradient. A safe curvature and a safe altitude gradient may be selected such that the road vehicle never reaches a portion of the roadway without that portion of the roadway being within the line of sight of the vehicle for a selected minimum duration of time, such as for example 3 seconds, or 5 seconds, or 10 seconds.

In certain embodiments, if no high risk zone exists along the route, then the method may continue by repeating action block 620 where the route may be updated as the vehicle travels. If a high risk zone is identified, then the method continues at action block 630 as the vehicle continues traveling along the route. At action block 630, the aerial drone is launched from the road vehicle when the road vehicle approaches a high risk zone, i.e., before the road vehicle reaches the high risk zone. For example, the processor onboard the road vehicle may activate launch of the aerial drone when the road vehicle reaches a pre-determined distance from the high risk zone. For example, a drone launch distance (D_{L}) may be calculated as the product of the road vehicle velocity (Vᵥ) and the sum of the time for the drone to deploy (T) and an adjustable time constant for different road types, wherein the time for the drone to deploy (T) is equal to the quotient of the product of the road vehicle velocity (Vᵥ) and T_{P} over the difference of the drone velocity (V_{D}) and the road vehicle velocity (Vᵥ): D_{L}=Vᵥ*((Vᵥ*T_{P})/)(V_{D}−Vᵥ)+(T_{adj}).

At action block 640, the aerial drone is controlled to fly a selected distance ahead of the road vehicle. In certain embodiments, the selected distance (D_{S}) may equal the product of the road vehicle velocity (Vᵥ) and time threshold (Tₚ), e.g., D_{S}=Vᵥ*Tₚ. Time threshold (Tₚ) is used for driver or autonomous processer response to the emergency condition. Usually, it is set to about 1 second, or more than 1 second.

At inquiry block 645, the method inquires whether the road vehicle has passed through high risk zone, i.e., no portion of the high risk zone remains on the route ahead of the road vehicle. If yes, then the method continues at action block 650 by recalling and landing the aerial drone on the road vehicle. Then, the method may continue at action block 620. If the road vehicle has not passed through high risk zone, than the method continues with inquiry block 653.

At inquiry block 653, the method inquires whether the road vehicle and the aerial drone are located in the same road segment. If yes, then the method returns to action block 640 where the aerial drone is maintained at the selected distances (D_{S}) ahead of the road vehicle. If no, then the method inquires at inquiry block 657.

At inquiry block 657, the method inquires whether there is another road user, such as another vehicle, or a notable object on the next road segment ahead. For example, a notable object may be a deer or other animal on the roadway, a pothole, falling or fallen rocks, fallen trees or branches, ice, flooded water, or other hazards. For example, sensors onboard the aerial drone are utilized to sense an object at a location on the route ahead of the road vehicle. In certain embodiments, sensing the object at the location on the route ahead of the road vehicle with the aerial drone includes operating a radar sensor on the aerial drone to detect the object and acquire the relative position of the object. In other embodiments, sensing the object at the location on the route ahead of the road vehicle with the aerial drone comprises operating a sensor unit on the aerial drone to detect the object and acquire the relative position of the object.

If inquiry block 657 finds there is no other road user or object on the next road segment ahead, then the method returns to action block 640 where the aerial drone is maintained at the selected distances (D) ahead of the road vehicle. If there is another road user or an object on the next road segment ahead, then the method continues at action block 670.

At action block 660 the aerial drone communicates to the road vehicle data associated with the object, such as an image and/or other information, i.e., location, lane number, direction, static or moving, velocity, rate of acceleration, etc., of the other road user, i.e., and/or the location. In exemplary embodiments, communicating data associated with the object and/or the location to the road vehicle includes transmitting the data to a processor onboard the road vehicle.

At inquiry block 675, the method inquires whether a risk of collision exists for the road vehicle and the other road user or object. If no risk of collision exists, then the method returns to action block 640 where the aerial drone is maintained at the selected distances (D) ahead of the road vehicle. If a risk of collision exists for the road vehicle and the other road user or object, then at action block 680 the aerial drone communicates a warning to the road vehicle to warn a driver or to active an automated braking or steering maneuver for an automated road vehicle. In other words, the data associated with the object and/or the location is utilized to operate the road vehicle.

Further, at action block 690, the warning event is uploaded to a cloud database and/or broadcast or otherwise communicated to other road users within range on the roadway. For example, data associated with the object and/or the location of the object is uploaded to a cloud database or communicated to other road users. Thereafter, the method returns to inquiry block 645 where the method inquires whether the road vehicle has passed through high risk zone.

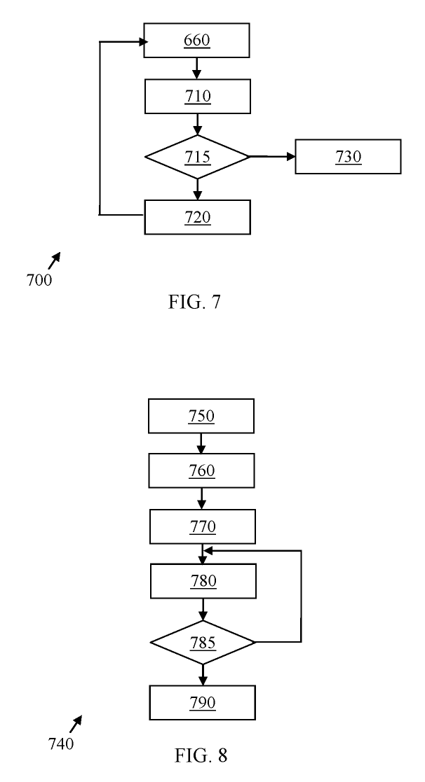

In FIG. 7, an exemplary method 700 for assisting operation of a road vehicle 512 with an aerial drone 520 further modifies method 600. For example, after the aerial drone communicates to the road vehicle data associated with the object or other road user at action block 660 of method 600, the processor onboard the road vehicle processes the data at action block 710.

Then, at inquiry block 715 the method inquires whether the object is recognized and identified from the data. If the object is not recognized, then the method continues at action block 720 with directing the aerial drone to capture more data associated with the object. Specifically, at action block 720 the vehicle drone control module commands the aerial drone to target on the object and capture additional data from other positions relative to the object, i.e., from other angles and/or distances. For example, the aerial drone may move direct above the object and/or provide 360 degree sensing of the object. The method then returns to action block 660 where the aerial drone communicates to the road vehicle the additional data associated with the object.

If the object is recognized at inquiry block 715, then the aerial drone is directed to stop capturing data associated with the object at action block 730. For example, the drone control module on the road vehicle may issue a command to release the object from further data gathering and continue detecting for other objects.

Method 700 enhances object detection and perception by utilizing the aerial drone to detect and perceive objects from more flexible angles than sensors onboard a road vehicle are capable of, increasing the robustness of the sensing system.

FIG. 8 illustrates another exemplary embodiment for a method 740 for assisting operation of a road vehicle with an aerial drone. The method 740 of FIG. 8 may be used in conjunction with or in position of various actions described in the methods and systems above. In the method of FIG. 8, action block 750 includes flying the aerial drone on a route ahead of the road vehicle or user, such as after launch of the aerial drone from the road vehicle. Control of the aerial drone may be performed as discussed above. For example, flying the aerial drone on the route ahead of the road vehicle may include controlling the distance between the aerial drone and the road vehicle with the drone control module. In certain embodiments, the distance between the aerial drone and the road vehicle is set by a user in the road vehicle through the drone control module onboard the road vehicle. The distance may be automatically or manually adjusted based on weather conditions. The aerial drone receives the road vehicle velocity and direction or heading angle through V2X communication from the road vehicle. As a result, the aerial drone flies at the same velocity and with the same heading angle as the road vehicle.

Method 740 further includes at action block 770 communicating a command to activate the aerial drone to emit light. In certain embodiments, the command is communicated from the drone control module in the road vehicle to the aerial drone to activate the aerial drone to emit light. In other embodiments, the command is communicated from a sensor on the aerial drone. For example, action block 770 may include sensing light conditions on the route ahead of the road vehicle with a light sensor on the aerial drone, and may communicate a command to emit light in response to low light conditions sensed by the light sensor. In response to the command, method 740 at action block 780 emits light from the aerial drone to improve visibility of the route ahead of the road vehicle.

Method 740 further includes inquiry block 785 which inquires whether an obstacle to the aerial drone is located in the vehicle route ahead. For example, the aerial drone may use sensors to detect an obstacle such as an overpass, a tunnel, or the like. If no obstacle is detected, the method 740 continues with action block 780. If an obstacle is detected, then at action block 790 the aerial drone communicates a request to the road vehicle to prepare for landing, such as opening a landing pad, and the aerial drone returns to and lands on the road vehicle. The aerial drone may later re-launch as described above.

It is further noted that the method may command the aerial drone to provide lighting for the user outside of the road vehicle, such as while walking from the road vehicle to doorway to a home or business. The walking portion of the route may be selected by the vehicle processor in the same manner that the driven portion of the route is identified and analyzed.

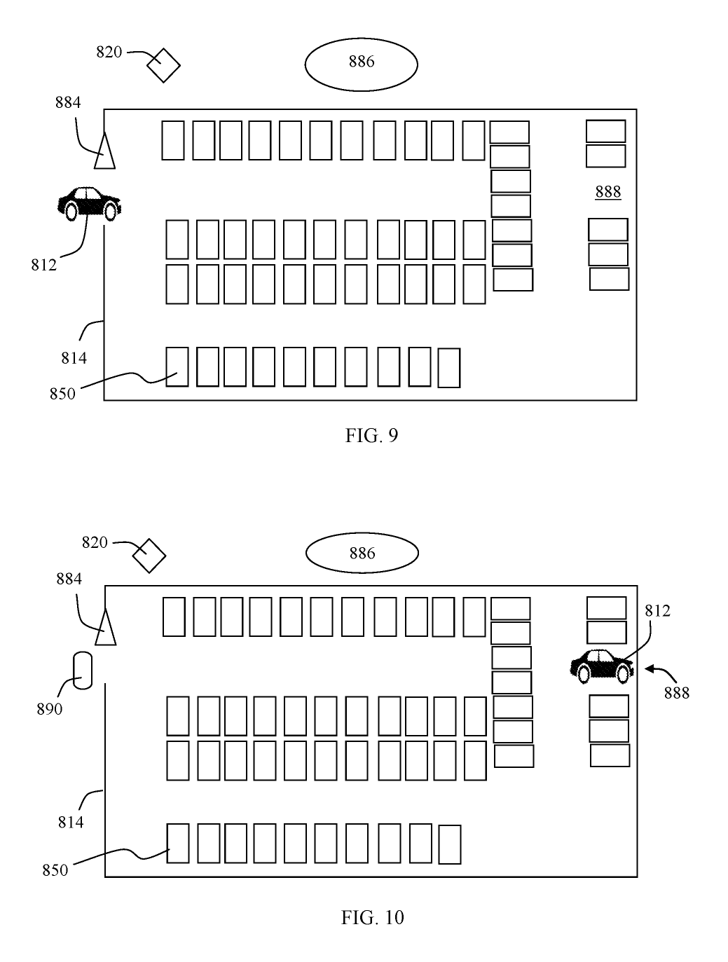

FIGS. 9 and 10 provide schematic representations of an exemplary embodiment of a system 800 for assisting operation of a road vehicle 812 with an aerial drone 820, specifically through leading a user to and from a parking location in a parking lot. In FIG. 9, the system 800 includes a road vehicle 812 that is shown entering a parking lot 814. While the road vehicle 812 is illustrated as being a car, any suitable road vehicle may be provided.

As shown, a kiosk 884 may be provided at the entrance of the parking lot 814. If provided, the kiosk 816 is adapted for communication with a server 886. Alternatively, the road vehicle 812, or a communication device therein, such as a cell phone, may be adapted for direct communication with the server 886. Communication between the server 886, road vehicle 812, aerial drone 820, and kiosk 884 may be provided by wifi, Bluetooth, 5G, or other network.

As shown, other vehicles 850 are parking in the parking lot 814. An available parking spot or location 888 is not visible from the entrance of the parking lot 814.

In an exemplary embodiment, a user enters a request for a parking location for the road vehicle 812. For example, a driver or passenger in the road vehicle 812, or a control module thereof, enters the request for a parking location. The request may be entered at the kiosk 884 such that the kiosk communicates the request to the server 886. Alternatively, the request may be communicated from the road vehicle 812 or from a user therein directly to the server 886.

In an exemplary embodiment, the server 886 maintains a map of the parking lot and occupied and non-occupied parking locations therein. The server 886 may include a sensor such as a camera for maintain the map in real time. When requested for a parking location, the server 886 identifies a suitable parking location, such as available parking spot 888, and assigns that parking spot 888 to the road vehicle 812.

The server 886 communicates the location of the parking spot 888 to the drone 820. In certain embodiments, the aerial drone 820 may be part of a fleet of aerial drones associated with the parking lot 814. In such embodiments, the server 886 may assign which aerial drone 820 is to be used. In other embodiments, the parking lot 814 includes a single aerial drone 820. In yet other embodiments, the aerial drone 820 is associated with the road vehicle 812 and enters the parking lot 814 with the road vehicle 812.

The server 886 may also communicate a selected route for the road vehicle 812 to travel to the assigned parking spot 888. Alternatively, the aerial drone 820 may determine the selected route to the assigned parking spot 888. After the aerial drone 820 receives the assigned parking spot 888 from the server 886, the system 800 operates the aerial drone 820 to lead the user to the parking location 888.

In the embodiment of FIG. 9, the aerial drone 820 leads the user in the road vehicle 812 to the parking location 888. In certain embodiments, the road vehicle 812 or the user therein may communicate the request for a parking location to the server 886 ahead of time, i.e., before arriving at the parking lot 814, to reserve the parking location.

FIG. 10 is a schematic representation of a further exemplary embodiment of the system 800 for assisting operation of a road vehicle 812 with an aerial drone 820. In FIG. 10, the road vehicle 812 is parked at parking location 888. A user 890, such as driver or passenger of the road vehicle 812 is shown walking onto the parking lot 814. The user 890 enters a request for the parking location 888 where the road vehicle 812 is parked. For example, the user 890 may enter a road vehicle identifier of the parked road vehicle 812, such as a license plate, vehicle description, parking spot number, or other identifier. The user 890 may enter the request via the kiosk 884 or may enter the request directly to the server 886, such as with a cell phone.

Upon receiving the request, the server 886 identifies the parking location 888 of the parked road vehicle 812. The server may keep a record of assigned parking locations or may perceive the location of the requested vehicle through sensors.

The server 886 communicates the location of the parking spot 888 to the drone 820. As described above, the aerial drone 820 may be part of a fleet of aerial drones associated with the parking lot 814 and be assigned by the server 886 for use. Alternatively, the parking lot 814 may include a single aerial drone 820 or the aerial drone 820 may be associated with the road vehicle 812.

The server 886 may also communicate a selected route for the user 890 to travel to the assigned parking spot 888. Alternatively, the aerial drone 820 may determine the selected route to the assigned parking spot 888. After the aerial drone 820 receives the location of the assigned parking spot 888 from the server 886, the system 800 operates the aerial drone 820 to lead the user 890 to the parking location 888.

As described herein, methods and systems for assisting operation of a road vehicle with an aerial drone are provided. The methods and systems utilize an aerial drone to increase the effective range of vision for a driver or autonomous road vehicle. Further, the methods and systems utilize an aerial drone to provide additional lighting for a user, whether in the road vehicle or walking to or from the road vehicle. Also, the methods and systems utilize an aerial drone to lead a road vehicle to an available parking spot and to lead a user to a road vehicle parked in a parking spot.

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the claimed subject matter in any way. Rather, the foregoing detailed description will provide those skilled in the art with a convenient road map for implementing an exemplary aspect of the subject matter. It being understood that various changes may be made in the function and arrangement of elements described in an exemplary aspect without departing from the scope of the subject matter as set forth in the appended claims.

What is claimed is:

1. A method for assisting operation of a road vehicle with an aerial drone, the method comprising:
flying the aerial drone on a route ahead of the road vehicle;
sensing an object at a location on the route ahead of the road vehicle with the aerial drone;
communicating data associated with the object and/or the location to the road vehicle; and
utilizing the data to operate the road vehicle.

2. The method of claim 1 further comprising:
determining that a high risk zone is on the route ahead of the road vehicle; and
launching the aerial drone from the road vehicle before the road vehicle reaches the high risk zone, wherein flying the aerial drone on the route ahead of the road vehicle comprises flying the aerial drone in the high risk area.

3. The method of claim 1 further comprising:
determining that no high risk zone is on the route ahead of the road vehicle; and
recalling and landing the aerial drone on the road vehicle.

4. The method of claim 2 wherein determining that a high risk zone is on the route ahead of the road vehicle comprises performing a map data analysis to determine whether a road curvature of the route is greater than a safe curvature and whether an altitude gradient of the route is greater than a safe altitude gradient.

5. The method of claim 2 wherein determining that a high risk zone is on the route ahead of the road vehicle comprises compiling and reviewing traffic accident data for the route ahead of the road vehicle.

6. The method of claim 1 wherein sensing the object at the location on the route ahead of the road vehicle with the aerial drone comprises operating a radar sensor on the aerial drone to detect the object and acquire a relative position of the object.

7. The method of claim 1 wherein sensing the object at the location on the route ahead of the road vehicle with the aerial drone comprises operating a sensor unit on the aerial drone to detect the object and acquire a relative position of the object.

8. The method of claim 1 wherein communicating data associated with the object and/or the location to the road vehicle comprises transmitting the data to a processor onboard the road vehicle.

9. The method of claim 1 further comprising:
attempting to recognize the object from the data; and
if the object is not recognized, directing the aerial drone to capture more data associated with the object.

10. The method of claim 1 further comprising:
attempting to recognize the object from the data; and
if the object is recognized, directing the aerial drone to stop capturing data associated with the object and to continue sensing for other objects.

11. The method of claim 1 further comprising uploading the data associated with the object and/or the location to a cloud database.

12. A method for assisting operation of a road vehicle with an aerial drone, the method comprising:
entering a request from a user for a parking location for the road vehicle;
identifying the parking location; and
operating the aerial drone to lead the user to the parking location.

13. The method of claim 12 wherein the aerial drone leads the user in the road vehicle to the parking location.

14. The method of claim 12 wherein the aerial drone leads the user to the road vehicle parked in the parking location.

15. The method of claim 12 wherein:
entering the request from the user for the parking location comprises communicating the request to a server;
the server identifies the parking location; and
the server assigns the aerial drone to lead the user to the parking location.

16. The method of claim 12 wherein:
the aerial drone is associated with the road vehicle;
entering the request from the user for the parking location comprises communicating the request to a server;
the server identifies the parking location; and
the server communicates the parking location to the aerial drone.

17. The method of claim 12 wherein:
entering the request from the user for the parking location comprises entering a road vehicle identifier of the road vehicle, when parked;
entering the request from the user for the parking location comprises communicating the road vehicle identifier of the road vehicle to a server;
the server identifies the parking location of the road vehicle; and
the server assigns the aerial drone to lead the user to the parking location.

18. A method for assisting operation of a road vehicle with an aerial drone, the method comprising:
flying the aerial drone on a route ahead of the road vehicle; and
emitting light from the aerial drone to improve visibility of the route ahead of the road vehicle.

19. The method of claim 18 further comprising communicating a command from a drone control module in the road vehicle to activate the aerial drone to emit light, wherein flying the aerial drone on the route ahead of the road vehicle comprises controlling a distance between the aerial drone and the road vehicle with the drone control module.

20. The method of claim 18 further comprising sensing light conditions on the route ahead of the road vehicle with a light sensor on the aerial drone, wherein the aerial drone emits light in response to low light conditions sensed by the light sensor.
